(19) United States
(12) Patent Application Publication
(10) Pub. No.: US 2014/0285461 A1
(43) Pub. Date: Sep. 25, 2014

(54) Input Mode Based on Location of Hand Gesture

(71) Applicants: Robert Campbell, Cupertino, CA (US); Stanley Xu, San Jose, CA (US)

(72) Inventors: Robert Campbell, Cupertino, CA (US); Stanley Xu, San Jose, CA (US)

(21) Appl. No.: 14/353,308

(22) PCT Filed: Nov. 30, 2011
(86) PCT No.: PCT/US2011/062573

§ 371 Date: Apr. 22, 2014

(51) Int. Cl. G06F 3/01; G06F 3/0488

(52) U.S. Cl. CPC G06F 3/017; G06F 3/0488
USPC 345/173

(57) ABSTRACT

A device to detect an initial location and an end location of a hand gesture from a user, identify an input mode for the device based on at least one of the initial location and the end location of the hand gesture, and execute an input command on the device corresponding to the input mode and the hand gesture from the user.

### BACKGROUND

When interacting with a user interface rendered on a device, a user can access an input component of the device, such as a keyboard and/or a mouse. The user can reposition the mouse from one location to another to navigate the user interface and to access visual content rendered on the user interface. In another example, the user can utilize shortcut keys on the keyboard to navigate and to access visual content on the user interface.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device according to an example.

FIG. 2 illustrates a display component rendering a user interface and a sensor to detect a hand gesture from a user according to an example.

FIG. 3 illustrates a block diagram of an input application identifying an input mode for a device according to an example.

FIG. 4 is a flow chart illustrating a method for detecting an input for a device according to an example.

FIG. 5 is a flow chart illustrating a method for detecting an input for a device according to another example.

### DETAILED DESCRIPTION

A device includes a sensor to detect information of a hand gesture from a user for the device to detect an initial location and an end location of the hand gesture. The initial location corresponds to where the hand gesture begins and the end location corresponds to where the hand gesture ends. The sensor can be a touchpad or a touch surface to detect the user touching a surface of the sensor to make one or more hand gestures. In response to detecting the initial location and the end location of the hand gesture, the device can identify an input mode for the device. An input mode for the device corresponds to how the device interprets and processes a hand gesture as an input command for the device.

In one embodiment, an input mode can include a swipe mode for the user to navigate between content displayed on a user interface. The content can include an application, file, media, menu, setting, and/or wallpaper of the device. In another embodiment, an input mode can include a pointer mode for the user to access and navigate content which is presently rendered for display on the user interface. If either the initial location or the end location of the hand gesture are within proximity of an edge of the sensor, the device will identify the input mode for the device to be a swipe mode. In another embodiment, if neither the initial location nor the end location of the hand gesture are within proximity of any edge of the sensor, the device will identify the input mode to be a pointer mode.

In response to identifying an input mode, the device can identify an input command to execute on the device corresponding to the identified input mode and information of the touch gesture from the user. For example, if the identified mode is a swipe mode, the input command can be to navigate between content and/or to bring a menu of the device into view on the user interface. In another example, if the identified input is a pointer mode, the input command can be to navigate the presently rendered content by repositioning a cursor or a pointer over an area of the presently rendered content. As a result, the device can accurately identify one or more input commands on the device for a user to access and navigate a user interface with one or more hand gestures.

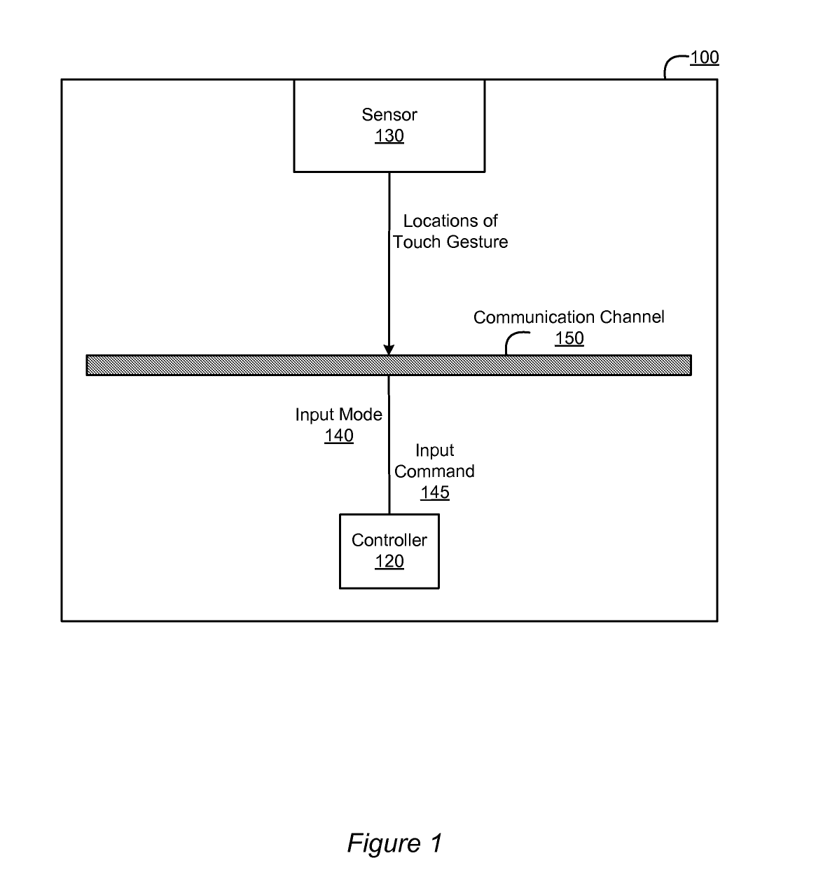

FIG. 1 illustrates a device 100 according to an example. The device 100 can be a laptop, a notebook, a tablet, a netbook, an all-in-one system, and/or a desktop. In another embodiment, the device 100 can be a cellular device, a PDA (Personal Digital Assistant), an E (Electronic)-Reader, and/or any additional device which can identify an input mode 140 and an input command 145 for the device 100. The device 100 includes a controller 120, a sensor 130, and a communication channel 150 for components of the device 100 to communicate with one another. In another embodiment, the device 100 includes an input application which can be utilized independently and/or in conjunction with the controller 120 to manage the device 100. The input application can be a firmware or application which can be executed by the controller 120 from a non-transitory computer readable memory of the device 100.

For the purposes of this application, an input mode 140 of the device 100 corresponds to how the controller 120 and/or the input application interpret a hand gesture to identify an input command 145 of the device 100. In one embodiment, an input mode 140 includes a swipe mode. If the device 100 is in a swipe mode, a hand gesture from a user can be interpreted as an input command 145 to navigate between content displayed on a user interface of the device 100. The user interface includes visual content such as files, documents, media, applications, and/or wallpaper. In another example, the visual content can include a menu and/or settings of a file, an application, and/or an operating system of the device 100. In other embodiments, an input mode 140 can include a pointer mode of the device 100. If the device 100 is a pointer mode, a hand gesture from the user can be interpreted as an input command 145 to access content presently rendered for display on the user interface. Additionally, the pointer mode can be used to navigate the content rendered on the user interface.

When determining which input mode 140 to use for the device 100, a sensor 130 of the device 100 can initially detect for a hand gesture from a user of the device 100. The user can include any person which can access the device 100 by making one or more hand gestures. A hand gesture can include one or more fingers and/or hand of the user coming within proximity of the sensor 130. In another embodiment, a hand gesture can include the user making a motion with at least one finger and/or a hand within proximity of the sensor 130. In other embodiments, the hand gesture can be a touch gesture where a hand or a finger of the user touches and/or maintains contact with a surface of the sensor 130. For the purposes of this application, the sensor 130 is a hardware component of the device 100 which can detect a hand or finger of the user as the user is making one or more hand gestures. In one embodiment, the sensor 130 can be a touchpad and/or a touch surface of the device 100.

When detecting the hand gesture, the sensor 130 can detect information of the hand gesture. The information can include one or more coordinates corresponding to accessed locations of the sensor 130. One or more coordinates can include an initial location and an end location of the hand gesture. The initial location corresponds to a location where the hand gesture is detected by the sensor 130 to begin. The end location corresponds to a location where the hand gesture is detected by the sensor 130 to end. In another embodiment, the information can identify a number of fingers used in the hand gesture. In other embodiments, the information can include whether the hand gesture includes a motion and a direction of the motions.

For example, if the user makes a hand gesture by touching a top-center location of the sensor 130 and moving to a bottom-center location of the sensor 130, the initial location of the hand gesture is identified by the controller 120 and/or the input application to be top-center edge and the end location of the hand gesture is identified to be bottom-center. Additionally, the hand gesture includes a motion which moves downward from the top to the bottom. In another example, if the user makes a hand gesture by touching the center location of the sensor 130 and releasing the center location of the sensor 130, the controller 120 and/or the input application determine that the initial location and the end location of the hand gesture are the center of the sensor 130. Additionally, the hand gesture does not include any motions.

In response to detecting a hand gesture, the sensor 130 can pass information of the hand gesture to the controller 120 and/or the input application. The controller 120 and/or the input application can use the detected information to identify an input mode 140 for the device 100 by determining whether the first location and/or the end location of the hand gesture include a location within proximity of an edge of the sensor 130. The edge can include a top edge, a bottom edge, a left edge, and/or a right edge of the sensor 130. In one embodiment, the edge of the sensor 130 includes a perimeter of a touchpad or touch surface. The controller 120 and/or the input application can compare a coordinate of the initial location and/or a coordinate of the end location of the hand gesture to coordinates of the perimeter of the sensor 130.

If the coordinate of the initial location and/or the end location match a coordinate of the perimeter, the controller 120 and/or the input application determine that the input mode 140 for the device 100 is a swipe mode. In another embodiment, if neither the coordinate of the initial location and the coordinate of the end location do not match any of the coordinates of the perimeter, the controller 120 and/or the input application determine that the input mode 140 for the device 100 is a pointer mode. In response to identifying the input mode 140 for the device 100, the controller 120 and/or the input application identify an input command 145 of the device 100 corresponding to the input mode 140 and the hand gesture. For the purposes of this application, an input command 145 includes an input instruction to access and/or navigate the user interface.

In one embodiment, if the input mode 140 is a swipe mode, the hand gesture can be used to navigate between content on the user interface. In another embodiment, if the input mode 140 is a pointer mode, the hand gesture can be used to access and navigate a presently rendered content on the user interface. When identifying an input command 145, the controller 120 and/or the input application can compare the information of the hand gesture to predefined information of input commands 145 corresponding to the identified input mode 140. In response to identifying the input command 145, the controller 120 and/or the input application can execute the input command 145 on the device 100.

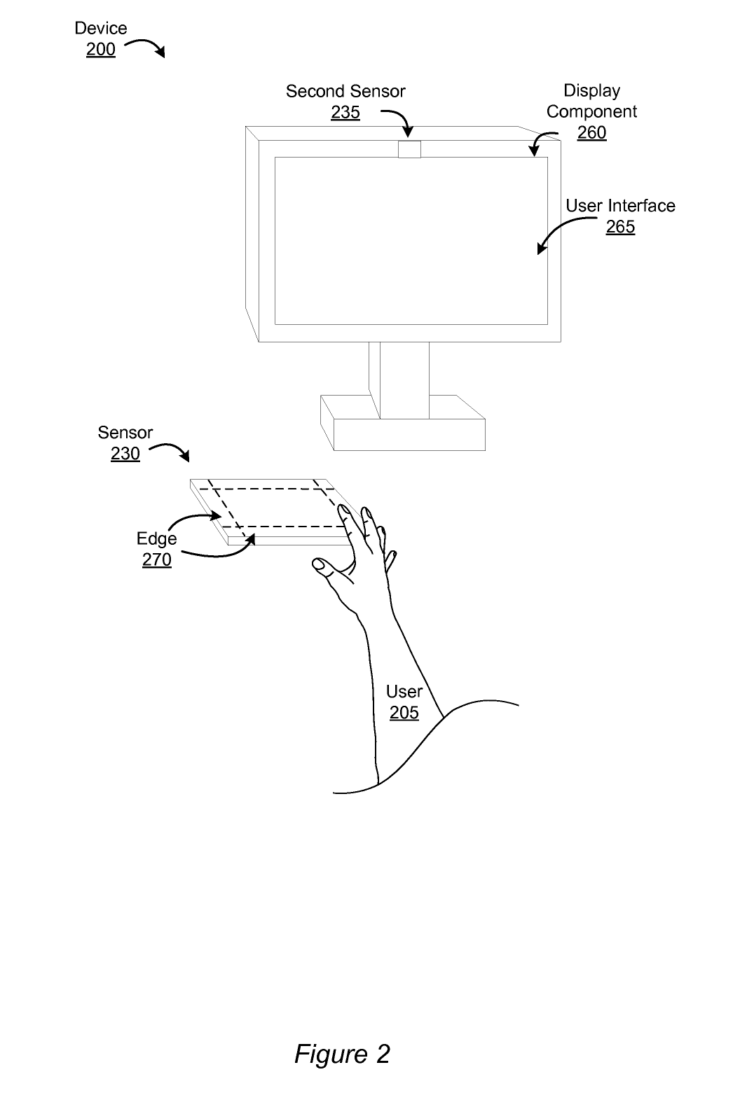

FIG. 2 illustrates a display component 260 rendering a user interface 265 and a sensor 230 to detect a hand gesture from a user according to an example. The display component 260 is a hardware output component which can display and/or modify a user interface 265 to include visual content for a user 205 of the device 200 to view and/or interact with. In one embodiment, the display component 260 is a LCD (liquid crystal display), a LED (light emitting diode) display, a CRT (cathode ray tube) display, a plasma display, a projector and/or any additional device configured to display the user interface 265 to include visual content. The visual content can include a file, a document, media, a menu, settings, and/or wallpaper of the device 200.

The user 205 can access and/or interact with the user interface 265 by making one or more hand gestures for a sensor 230 to detect. The hand gesture can be made with at least one finger and/or hand of the user 205. Additionally, the hand gesture can include the user 205 touching the sensor 230 and/or making one or more motions while touching the sensor 230. As noted above, the sensor 230 is a hardware component of the device 200 which can detect one or more hand gestures from the user 205. The sensor 230 can include a touchpad, a touch surface, and/or any additional hardware component which can detect a hand and/or finger of the user 205. In one embodiment, the sensor 230 can be integrated as part of the device 200. In another embodiment, the sensor 230 can be a peripheral component coupled an interface port of the device 200.

As shown in FIG. 2, the sensor 230 can include one or more edges 270 around a perimeter of the sensor 230. One or more edges 270 of the sensor 230 can include a top edge, a bottom edge, a left edge, and/or a side edge. In one embodiment, as shown in FIG. 2, the sensor 230 can include one or more visible markings to display where the edges are located. A visible marking can be a visible printing on the surface of the sensor 230. In another embodiment, a visible marking can include crevices or locations on the surface of the sensor 230 which are illuminated from a light source of the device 200. In other embodiments, a visible marking can be any additional visible object which can be used to indicate a location of one or more edges of the sensor 230.

When detecting a hand gesture, the sensor 230 can detect information of the hand gesture from the user 205. The information can include a number of fingers used in the hand gesture. In another embodiment, the information can include an initial location of the hand gesture and an end location of the hand gesture. As noted above, the initial location corresponds to where the hand gesture is detected by the sensor 230 to begin. For example, the initial location can be a coordinate of where the user initially touches a surface of the touchpad or touch surface. The end location corresponds to where the hand gesture is detected by the sensor 230 to end. For example, the end location can be a coordinate of where the user last touches a surface of the touchpad or touch surface. In other embodiments, the information can include whether the hand gesture includes any motions and/or a direction of any of the motions.

In response to detecting information of the hand gesture, a controller and/or an input application of the device 200 identify an input mode for the device 200 based on the initial location and/or the end location of the hand gesture. In another embodiment, as illustrated in FIG. 2, the device 200 additionally includes a second sensor 235 to detect information of the hand gesture, such as the initial location and the end location. Similar to the sensor 230, the second sensor 235 is a hardware component of the device 200 which can detect the user 205 making one or more hand gestures. In one embodiment, the second sensor is an image capture component, a proximity sensor, an infrared component, and/or any additional device which can detect additional information of the hand gesture from a different view or perspective. Using the additional information from the second sensor 235, a controller and/or an input application can confirm the information of the hand gesture detected by the sensor 230 by detecting the hand gesture from a different perspective. Using the detected information, the controller and/or the input application can accurately identify an input mode for the device 200 and an input command to execute on the device 200.

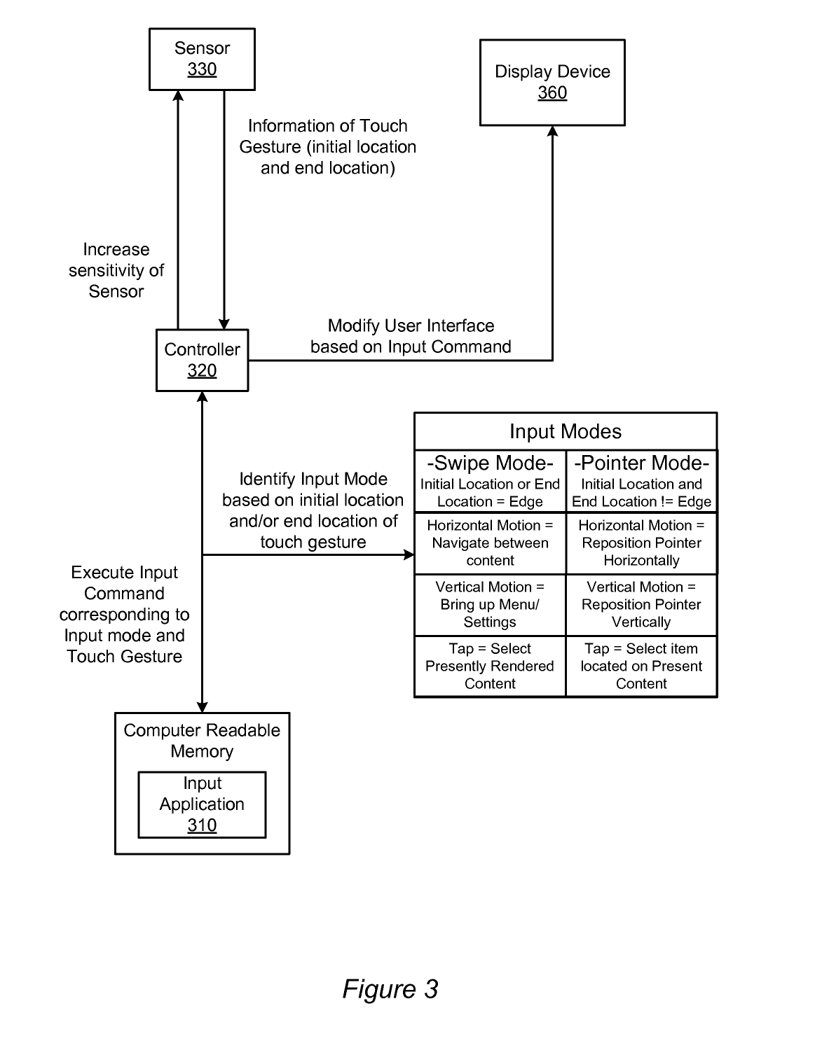

FIG. 3 illustrates a block diagram of an input application 310 identifying an input mode of a device based on an initial location and/or an end location of a hand gesture according to an example. In one embodiment, the input application 310 can be a firmware embedded onto one or more components of the device. In another embodiment, the input application 310 can be an application accessible from a non-volatile computer readable memory of the device. The computer readable memory is a tangible apparatus that contains, stores, communicates, or transports the application for use by or in connection with the device. In one embodiment, the computer readable memory is a hard drive, a compact disc, a flash disk, a network drive or any other form of tangible apparatus coupled to the device.

The controller 320 and/or the input application 310 can instruct the sensor 330 to detect information of the hand gesture. In one embodiment, the controller 320 and/or the input application 310 can additionally increase a sensitivity of the sensor 330 in response to the sensor 330 detecting one or more fingers from the user. Increasing the sensitivity of the sensor 330 can include increasing an amount of power supplied to the sensor 330. In another embodiment, the controller 320 and/or the input application 310 can increase a sensitivity of the edges of the sensor 330 without increasing a sensitivity of other areas or portions of the sensor 330.

As shown in FIG. 3, the sensor 330 has detected information of a hand gesture from a user. The information includes an initial location of where the hand gesture begins on the sensor 330 and an end location of where the hand gesture ends. The initial location and the end location can include a coordinate of where on a surface of the sensor 330 the hand gesture begins and ends. In another embodiment, the information can include a number of fingers used in the hand gesture. In other embodiments, the information can include whether the hand gesture includes a motion and/or a direction of the motion.

In response to receiving the information of the hand gesture, the controller 320 and/or the input application 310 can identify an input mode of the device based on the initial location and/or the end location of the hand gesture. In one embodiment, when identifying the input mode, the controller 320 and/or the input application 310 access a list, table, and/or database of input modes for the device. The list, table, and/or database of input modes can be locally stored on the device or remotely accessed from another device. As shown in the present embodiment, the device includes a swipe mode and a pointer mode. The swipe mode is used to navigate between content of the user interface and the pointer mode is used to access and/or navigate a presently rendered content of the user interface. In other embodiments, the device can include additional input modes in addition to and/or in lieu of those noted above and illustrated in FIG. 3.

If the controller 320 and/or the input application 310 determine that the initial location and/or the end location of the hand gesture are within proximity of an edge of the sensor 330, the input mode for the device will be identified to be the swipe mode. The hand gesture is within proximity of the edge if at least one finger touches a location on a surface of the sensor 330 corresponding to an edge of the sensor 330. As noted above, the surface of the sensor 330 can include visible markings which show where on the sensor 330, an edge is located. In another embodiment, the hand gesture is within proximity of the edge if at least one finger touches a location of the sensor 330 within a predefined distance from the edge.

In one embodiment, the controller 320 and/or the input application 310 can additionally determine if more than one finger is detected to be touching the sensor 330 before identifying the input mode to be the swipe mode. In another embodiment, the controller 320 and/or the input application further determine if a first finger of the hand gesture is within proximity of an edge of the sensor 330 and if a second finger of the hand gesture is within proximity of the center of the sensor 330 before identifying the input mode to be the swipe mode. If the controller 320 and/or the input application 310 determine that neither the initial location nor the end location are within proximity of an edge of the sensor 330, the input mode for the device will be identified to be the pointer mode.

In response to identifying the input mode of the device, the controller 320 and/or the input application 310 proceed to identify an input command on the device corresponding to the input mode and the hand gesture. The input command includes an executable input instruction to access and/or navigate the user interface. As shown in FIG. 3, the list, table, and/or database of input modes can list input commands corresponding to an input mode and a hand gesture. Each input mode can include different input commands which can be executed on the device based on information of the detected hand gesture.

The controller 320 and/or the input application 310 compare information of the hand gesture detected by the sensor 330 to predefined information corresponding to an input command to determine which input command to execute. In one embodiment, if the input mode was previously identified to be the swipe mode and the information of the hand gesture specified that it included a horizontal motion, the controller 320 and/or the input application 310 identify the input command to be an instruction to navigate between content on the user interface. The controller 320 and/or the input application 310 can execute the input command on the device. Additionally, the controller 320 and/or the input application 310 modify the user interface of the display component 360 to display switching between content. Switching between content of the user interface can include switching from one open application or file to another.

In another embodiment, if the input mode is identified to be the swipe mode and the information of the hand gesture specified a vertical motion, the controller 320 and/or the input application 310 identify the input command to switch between content by sliding a menu bar into view on the user interface. As noted above, the menu bar can be a menu or settings of the presently rendered content, such as a file, application, and/or for an operating system of the device.

In other embodiments, if the input mode was previously identified to be a pointer mode and the information of the hand gesture specified that it included a horizontal motion, the controller 320 and/or the input application 310 identify the input command to be an instruction to navigate the presently rendered content by repositioning a pointer or cursor horizontally across the content. Additionally, the controller 320 and/or the input application 310 can modify the user interface of the display component 360 to display a pointer or cursor repositioning horizontally over the presently rendered content. In other embodiments, the controller 320 and/or the input application 310 can identify additional input commands for the device based on an input mode and information of a hand gesture in addition to and/or in lieu of those noted above.

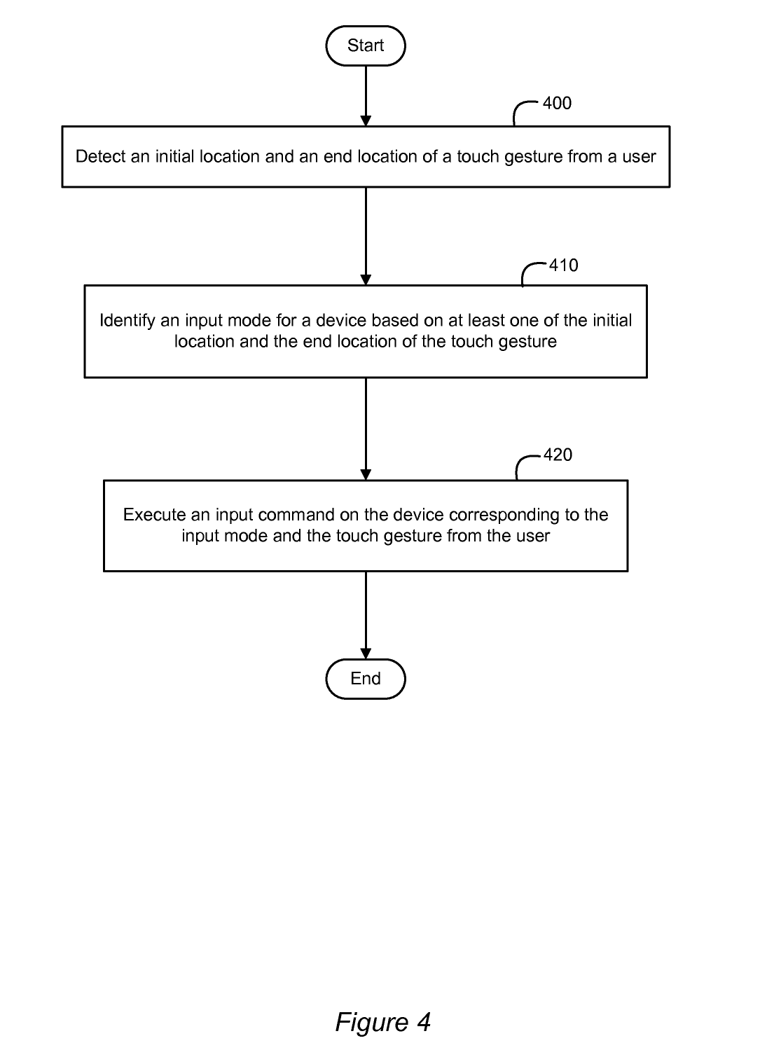

FIG. 4 is a flow chart illustrating a method for detecting an input for a device according to an example. A controller and/or input application can be utilized independently and/or in conjunction with one another to identify an input command of the device based on an input mode of the device and a hand gesture from a user. A sensor of device, such as a touchpad or touch surface, can initially detect information of a hand gesture for the controller and/or the input application to detect an initial location and an end location of a hand gesture from a user at 400. The information detected can include where on the sensor the user initially touches when making the hand gesture and where on the sensor the user last touches when making the hand gesture. In another embodiment, the information can include whether the hand gesture includes a motion and/or a direction of the motion.

The controller and/or the input application use the information detected from the sensor to identify the initial location and the end location of the hand gesture. As noted above, the initial location corresponds to where the hand gesture begins and the end location corresponds to where the hand gesture ends. Based on the initial location and/or the end location of the hand gesture, the controller and/or the input application can identify an input mode for the device at 410. An input mode corresponds to how the controller and/or the input application interpret the hand gesture as an input command for the device. If the controller and/or the input application determine that the initial location and/or the end location of the hand gesture are within proximity of an edge of the sensor, the input mode of the device can be identified as a swipe mode for the user to navigate between content of the user interface. In another embodiment, if the controller and/or the input application determine that neither the initial location nor the end location of the hand gesture are within proximity of an edge of the sensor, the input mode of the device can be identified as a pointer mode for the user to access and navigate a presently rendered content of the user interface.

In response to identifying the input mode for the device, the controller and/or the input application identify and execute an input command corresponding to the input mode and the hand gesture from the user at 420. As noted above, the controller and/or the input application can access a list, table, and/or database of input modes and each input mode can list input commands corresponding to the input mode and a hand gesture. The controller and/or the input application can compare the detected information of the hand gesture to predefined information of input commands listed under the identified input mode of the device. If a match is found under the identified input mode, the input command for the device is identified. The controller and/or the input application can then execute the input command on the device. The method is then complete. In other embodiments, the method of FIG. 4 includes additional steps in addition to and/or in lieu of those depicted in FIG. 4.

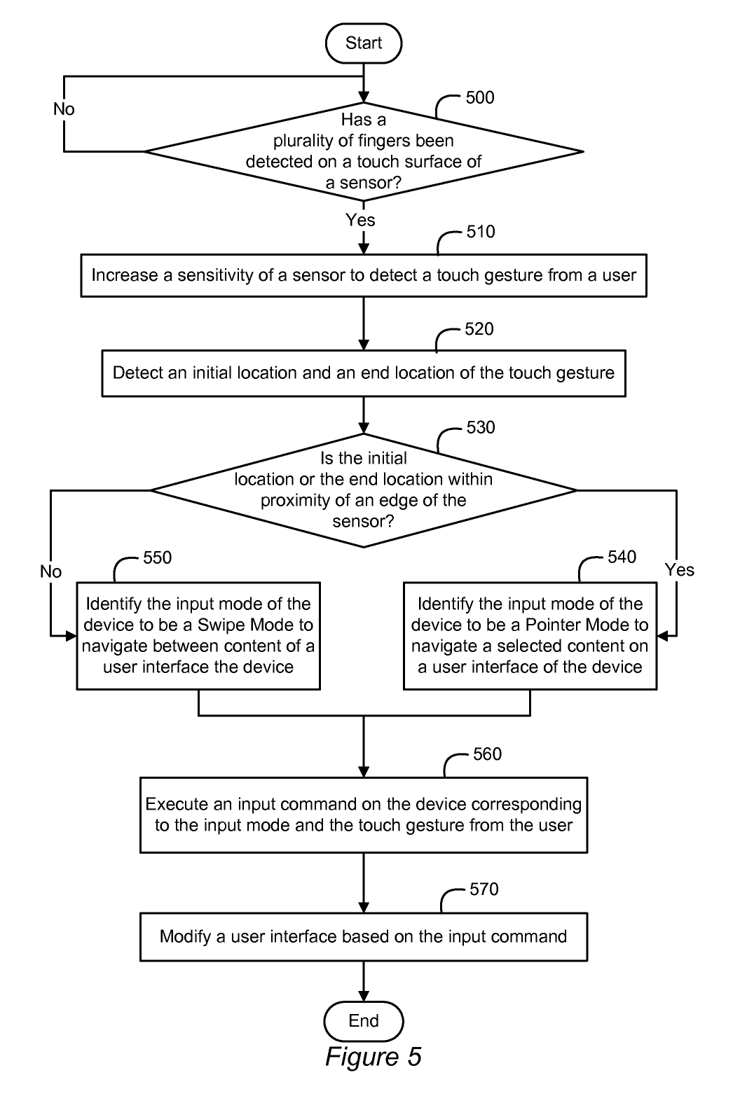

FIG. 5 is a flow chart illustrating a method for detecting an input for a device according to an example. The controller and/or the interface application initially use a sensor of the device to detect for a hand gesture from a user. In one embodiment, the sensor includes a touchpad or a touch surface to detect for a plurality of fingers touching a surface of the sensor at 500. If the sensor does not detect a plurality of fingers, the sensor continues to detect for a plurality of fingers at 500. If a plurality of fingers are detected, the controller and/or the input application can increase a sensitivity of the sensor to detect information of a hand gesture from the user at 510. Increasing the sensitivity of the sensor includes increasing an amount of power supplied to the sensor.

If a hand gesture is detected, the sensor can detect information of the hand gesture for the controller and/or the input application to identify the initial location and the end location of the hand gesture at 520. In one embodiment, the sensor can detect a coordinate of the initial touch location and a coordinate of the end touch location and share the coordinates with the controller and/or the input application. The sensor can additionally detect if the hand gesture includes a motion and/or a direction of the motion. The controller and/or the input application then determine if the initial location and/or the end location of the hand gesture are within proximity of an edge of the sensor at 530. As noted above, the edge includes a top edge, a bottom edge, a left edge, and/or a right edge of the surface of the sensor. The controller and/or the input application compare the coordinate of the initial location and the coordinate of the end location to coordinates of the edge to determine if the initial location and/or the end location of the hand gesture are within proximity of the edge of the sensor.

If neither the initial location nor the end location are within proximity of an edge of the sensor, the controller and/or the input application identify the input mode of the device to be a pointer mode for the user to access and navigate a presently rendered content on a user interface with the hand gesture at 540. In another embodiment, if either the initial location and/or the end location are within proximity of the edge of the sensor, the controller and/or the input application identify the input mode of the device to be a swipe mode for the user to navigate between content of the user interface with the hand gesture at 550.

In response to identifying the input mode for the device, the controller and/or the input application identify and execute an input command on the device corresponding to the identified input mode and the hand gesture from the user at 560. As noted above, the controller and/or the input application can access a table, list, and/or database of input modes which list input commands corresponding to an input mode. The controller and/or the input application can compare the detected information of the hand gesture to predefined information of input commands corresponding to the identified input mode. If a match is found, the input command is identified and the controller and/or the input application proceed to execute the input command on the device.

As the input command is executed, the controller and/or the input application can modify the user interface based on the input command at 570. If the input mode is a swipe mode, the controller and/or the input application can modify the user interface to display the user navigating between content.

Navigating between content can include switching from one application to another or bringing a menu into view on the user interface. In another embodiment, if the input mode is a pointer mode, the controller and/or the input application modify the user interface to display the user navigating the presently rendered content. Navigating the presently rendered content includes rendering a cursor or pointer to reposition over the presently rendered content. The method is then complete. In other embodiments, the method of FIG. 5 includes additional steps in addition to and/or in lieu of those depicted in FIG. 5.

What is claimed is:

1. A device comprising:
a sensor to detect an initial location and an end location of a hand gesture from a user; and
a controller to:
identify an input mode for the device to be at least one of a swipe mode or a pointer mode based on at least one of the initial location and the end location of the hand gesture; and
execute an input command on the device corresponding to the input mode and the hand gesture from the user.

2. The device of claim 1 wherein the sensor includes at least one of a touch surface and a touchpad.

3. The device of claim 2 wherein the sensor includes a visible mark to display at least one edge of the sensor.

4. The device of claim 1 further comprising a second sensor to detect the initial location and the end location of the hand gesture from the user.

5. The device of claim 4 wherein the second sensor includes at least one of an image capture component and a proximity sensor to detect the hand gesture of the user reposition over a surface of the sensor.

6. The device of claim 1 further comprising a display component to modify a user interface based on the input command.

7. The device of claim 1 wherein the swipe mode is used to navigate between content of a user interface the device.

8. The device of claim 1 wherein the pointer mode is used to navigate a presently rendered content on a user interface of the device.

9. A method for detecting an input for a device comprising:
detecting an initial location and an end location of a hand gesture from a user;
identifying an input mode for a device based on at least one of the initial location and the end location of the hand gesture; and
executing an input command on the device corresponding to the input mode and the hand gesture from the user.

10. The method for detecting an input for a device of claim 9 further comprising identifying the input mode of the device to be a swipe mode if at least one of the initial location and the end location of the hand gesture are within proximity of an edge of a touch surface of the device.

11. The method for detecting an input for a device of claim 9 further comprising identifying the input mode of the device to be a pointer mode if neither the initial location nor the end location of the hand gesture are within proximity of an edge of a touch surface of the device.

12. The method for detecting an input for a device of claim 9 wherein detecting the initial location and the end location of the hand gesture includes detecting for a plurality of fingers from the user.

13. The method for detecting an input for a device of claim 9 wherein detecting the initial location and the end location of the hand gesture includes detecting for at least one finger of the user within proximity of a center of a touch surface of the device.

14. A computer readable medium comprising instructions that if executed cause a controller to:
detect for a plurality of fingers from a user to detect an initial location and an end location of a hand gesture;
identify an input mode for a device based on at least one of the initial location and the end location of the hand gesture; and
execute an input command on the device corresponding to the input mode and the hand gesture from the user.

15. The computer readable medium of claim 14 wherein the controller modifies a sensitivity of a sensor to detect a finger of the user at an edge of a touch surface when detecting the initial location and the end location of the hand gesture.
